(19) United States
(12) Patent Application Publication
(10) Pub. No.: US 2005/0211667 A1
(43) Pub. Date: Sep. 29, 2005

(54) Method and apparatus for measurement of thin films and residues on semiconductor substrates

(75) Inventor: Yehiel Gotkis, Fremont, CA (US)

Correspondence Address: MARTINE PENILLA & GENCARELLA, LLP, 710 LAKEWAY DRIVE, SUITE 200, SUNNYVALE, CA, 94085, US

(73) Assignee: LAM RESEARCH CORPORATION, Fremont, CA (US)

(21) Appl. No.: 10/810,209

(22) Filed: Mar. 26, 2004

(51) Int. Cl. G01L 21/30; H01B 13/00

(52) U.S. Cl. 216/59; 216/60

(57) ABSTRACT

A method of sensing properties of materials on a substrate is provided. The method includes scanning along a path defined over a surface of a substrate that can have a film. The substrate is configured to spin when present. The method includes sensing properties of the film at a plurality of points along the path and generating a map of the film using information from the plurality of points along the path. An apparatus for sensing properties of materials on a substrate is also provided.

### CROSS REFERENCE TO RELATED APPLICATIONS

This application is related to U.S. patent application Ser. No. 10/186,472, entitled “INTEGRATION OF EDDY CURRENT SENSOR BASED METROLOGY WITH SEMICONDUCTOR FABRICATION TOOLS,” filed on Jun. 28, 2002. The disclosure of this Patent Application is incorporated herein by reference.

### BACKGROUND OF THE INVENTION

1. Field of the Invention

The invention relates generally to semiconductor fabrication and more specifically to measurement of films during wafer processing.

2. Description of the Related Art

In the fabrication of semiconductor devices, there is a need to measure material features on substrates. Typically, integrated circuit devices are manufactured in the form of multi-level structures. At the substrate level, transistor devices having p-type and n-type doped regions are formed. In subsequent levels, interconnect metallization lines are patterned and electrically connected to the transistor devices to define the desired functional device. Dielectric materials, such as silicon dioxide, insulate patterned conductive features. Etching paths through these layers provides a means for contacting semiconductor devices such as transistors. Metallization line patterns are formed in dielectric materials, and then metal CMP operations are performed to remove excess metallization.

During integrated circuit fabrication there are many opportunities for gathering metrology data, that is measuring material and device properties on substrates. Many properties can be determined by capturing a signal indicating the device, feature or material. As features and the thickness of films employed in the manufacture of semiconductors continue to decrease in size, the task of collecting metrology becomes more sophisticated and precise. Properties of materials on the substrate are carefully monitored throughout the fabrication process, but the task is more difficult during interlayer dielectric (ILD) stages, that is when stacks consist of multiple dielectric and metal film layers.

Optical sensors maybe used for non-contact thickness measurement of transparent films, such as silicon dioxide and other materials used in the manufacture of semiconductor devices. Optical techniques such as ellipsometry and reflectometry have been used extensively in the semiconductor arts for measurement of thin films (U.S. Pat. No. 4,899,055 “Thin Film Thickness Measuring Method” and U.S. Pat. No. 6,160,621 “Method and Apparatus for In-Situ Monitoring of Plasma Etch and Deposition Processes Using a Pulsed Broadband Light Source”). Typically measurement employing ellipsometry or reflectometry is accomplished at specific locations on a stationary substrate. The location of such measurement is typically predetermined to correlate with features or designs anticipated in a particular region of a substrate. For example, for measurement of a wafer 50 it is common to provide metrology from test points 20 as shown in FIG. 1 and FIG. 2, for 200 mm and 300 mm production, respectively. Pre-alignment of substrates is necessary, as most metrology instruments require a form of pattern recognition in order to determine accurate results. Typically a notch or fiducial is used for alignment of substrates, however other means may be used. Many systems require additional focusing of lenses used to collect signals reflected off materials on the substrate. In sum, the process of measurement is methodical and time consuming.

In view of the foregoing, a technique is needed for efficiently providing metrology for dielectric and conductive films on substrates not necessarily stationary.

### SUMMARY OF THE INVENTION

Broadly speaking, the present invention is an apparatus that measures film thickness on a semiconductor substrate. It should be appreciated that the present invention can be implemented in numerous ways, including as an apparatus, a system, a device, or a method. Several inventive embodiments of the present invention are described below.

In accordance with one embodiment of the present invention, a method is provided. The method includes spinning a substrate having a film and scanning an optical sensor across a path along a surface of the substrate. The method includes sensing properties of the film with the optical sensor at a plurality of points along the path and generating a map of the film using information from the plurality of points along the path.

In accordance with another embodiment of the present invention, a method is provided. The method includes scanning an optical sensor across a path defined along a surface of a substrate having a film when the substrate is spinning. The method also includes sensing properties of the film with the optical sensor at a plurality of points along the path and generating a map of the film using information from the plurality of points along the path.

In accordance with yet another embodiment of the present invention, a method is provided. The method includes scanning along a path defined over a surface of a substrate that can have a film. The substrate is configured to spin when present. The method includes sensing properties of the film at a plurality of points along the path and generating a map of the film using information from the plurality of points along the path.

In accordance with another embodiment of the present invention, an apparatus is provided. The apparatus includes a substrate holding and rotating mechanism and an arm. The arm includes an optical sensor that can be scanned over a surface of the substrate. The optical sensor is configured to sense properties of a film that can be present on the surface of the substrate. The optical sensor is also configured to sense the properties at a plurality of points along a path that the arm is capable of traversing over the surface of the substrate.

In accordance with one embodiment of the present invention, an apparatus is provided. The apparatus includes a substrate holding and rotating mechanism and an arm. The arm further includes an optical sensor that can be scanned over a surface of the substrate. The optical sensor is configured to sense properties of a film that can be present on the surface of the substrate at a plurality of points along a path that the arm is capable of traversing over the surface of the substrate. The optical sensor includes an illumination source capable of flashing and, a spectrograph capable of collecting and analyzing a signal reflected from the substrate. The arm also includes an inductive sensor capable of detecting conductive material properties at a plurality of points along a path that the arm is capable of traversing over the surface of the substrate. A data processor is capable of receiving the properties sensed by the optical sensor and the inductive sensor. The data processor is also capable of controlling the operation of the arm and the substrate holding and rotating mechanism and producing a map graphically indicating properties sensed.

In accordance with one embodiment of the present invention, computer readable media embodying computer code having program instructions is provided. The computer readable media includes program instructions for controlling spinning of a substrate having an film and for controlling scanning of an optical sensor across a path along a surface of the substrate. The computer readable media also includes program instructions for controlling sensing of properties of the film with the optical sensor at a plurality of points along the path for controlling generation of a map of the film using information from the plurality of points along the path.

The advantages of the present invention are numerous. Facilitation of film measurement by scanning sensors over a rotating substrate allows for efficient full surface mapping. Thickness mapping and knowledge of material properties obtained allows for adjustment of film thickness qualities in later processing steps to ensure proper device yield and minimize waste, otherwise known in wafer fabrication as scrap. Additionally, information obtained by the measurement system can allow for adjustment of earlier process parameters in order to achieve manufacturing conformance for subsequent substrates.

It is to be understood that the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of this specification, illustrate exemplary embodiments of the invention and together with the description serve to explain the principles of the invention.

FIG. 1 is a top view of test points on a 200 mm substrate.

FIG. 2 is a top view of test points on a 300 mm substrate.

FIG. 3 is a top view of an apparatus capable of providing metrology, in accordance with one embodiment of the present invention.

FIG. 4A provides a path affected by an arm traversing edge to center on a rotating substrate, in accordance with one embodiment of the present invention.

FIG. 4B provides a path affected by an arm traversing from the center outwards on a rotating substrate, in accordance with one embodiment of the present invention.

FIG. 5A is diagram of an arm with an optical sensor, in accordance with one embodiment of the present invention.

FIG. 5A-1 is a schematic of an optical sensor, in accordance with one embodiment of the present invention.

FIG. 5B is diagram of a second arm with an inductive sensor, in accordance with one embodiment of the present invention.

FIG. 5C is diagram of an arm with an optical sensor and an inductive sensor, in accordance with one embodiment of the present invention.

FIG. 6A provides a sample display of topographic information obtained from the sensors, in accordance with one embodiment of the present invention.

FIG. 6B illustrates the use of a table for the display of data obtained from the sensors, in accordance with one embodiment of the present invention.

FIG. 7 is a diagram of an apparatus capable of providing metrology, in accordance with one embodiment of the present invention.

FIG. 8 is a flow chart of a method for generating a map of film on a substrate, in accordance with one embodiment of the present invention.

FIG. 9 is a flow chart of program instructions capable of generating a map of film on a substrate, in accordance with one embodiment of the present invention.

### DETAILED DESCRIPTION OF THE INVENTION

This disclosure describes a method and apparatus for measuring properties of films on substrates. Several exemplary embodiments of the invention will now be described in detail with reference to the accompanying drawings. In the following description, numerous specific details are set forth in order to provide a thorough understanding of the present invention. It will be understood, however, to one skilled in the art, that the present invention may be practiced without some or all of these specific details. In other instances, well known process operations have not been described in detail in order not to unnecessarily obscure the present invention.

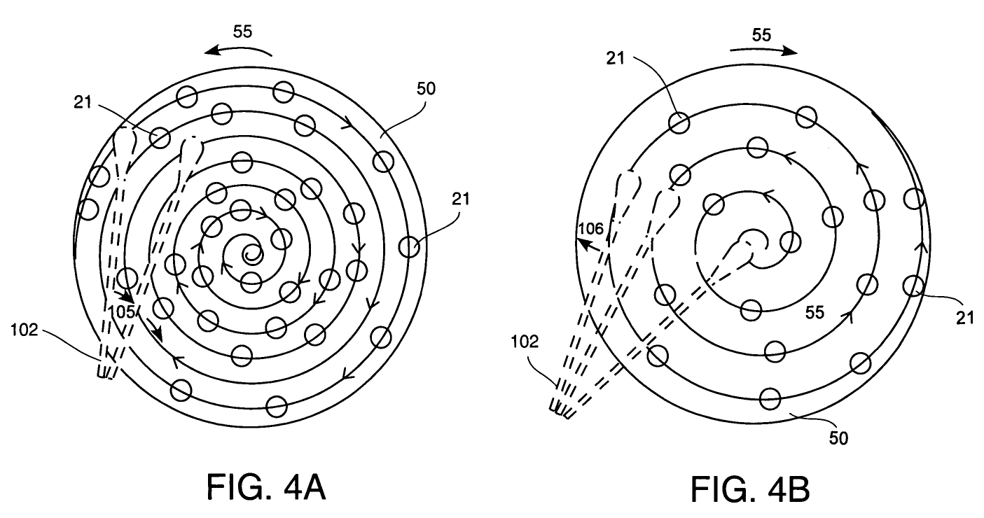

FIG. 3 provides a diagram of an apparatus capable of detecting material properties of substrates, in accordance with one embodiment of the present invention. Substrates as described herein include semiconductor wafers and other suitable work-pieces on which layers of material may be applied. A chuck 52, also known as a platform, holds and supports a substrate 50. The chuck 52 is capable of rotating the substrate 50 in a direction 55. A motor may be used to rotate the substrate 50. Any suitable technique for accomplishing rotation of the substrate 50 may be used, such as magnetic field acceleration, so long as the device used for rotation does not interfere with the measurement operations described below. The rotation of the substrate 50 can be accomplished so that the substrate 50 rotates in a substantially planar fashion. The direction 55, while shown in the clockwise direction, can alternatively be in the counter clockwise direction using the same methodology employed by the present invention.

An arm 102 is configured to traverse the surface of the substrate 50 from the edge of the substrate to the center of the substrate in a direction 105. Of course, the arm 102 may traverse the substrate from the center to the edge in a direction opposite that of direction 105. The movement of the arm 102 may be controlled by any suitable technique such as a step motor, servo motor, etc., in order to control path of travel over the substrate 50. A computer 150, may assist in controlling the movement of the arm 102 providing instructions such as the speed of the traverse and the width of the scan. Additionally, a second arm 102′ configured apart from the arm 102 by an angle theta, θ, could move from the center of the substrate 50 towards the edge of the substrate 50 in a direction 105 or as otherwise directed by the computer 150. If, for instance, the angle theta, θ, was fixed so that initially the arm 102 was stationed above the edge of the substrate 50 and the second arm 102′ was stationed above the center of the substrate 50, the arm 102 and the second arm 102′ could move simultaneously so that both the arm 102 and the second arm 102′ would cover the entire surface of the substrate 50 in rotation.

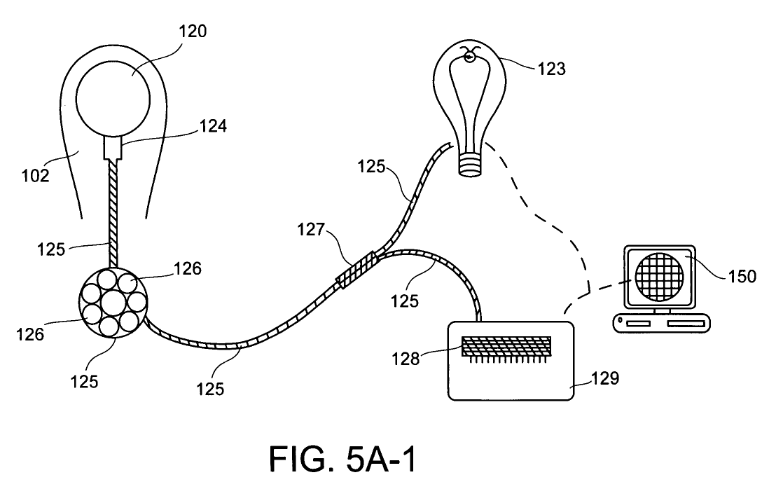

FIG. 4A illustrates a path affected by the arm 102 traversing from edge to center on the substrate 50 in rotation, in accordance with one embodiment of the present invention. As the substrate 50 is spinning in the direction 55, the arm 102 traversing over the surface of the substrate 50 in the direction 105 affects a spiral path. The computer 150 described above can automate the speed of rotation of the substrate 50 as well as the movement of the arm 102 to ensure sufficiently enough of the data points 21 are established to cover the entire surface of the substrate 50. The movement of the arm 102 over the surface of the substrate 50 affects one of a continuous trace and a point-to-point trace of the path. The computer 150 controls the number of data points 21.

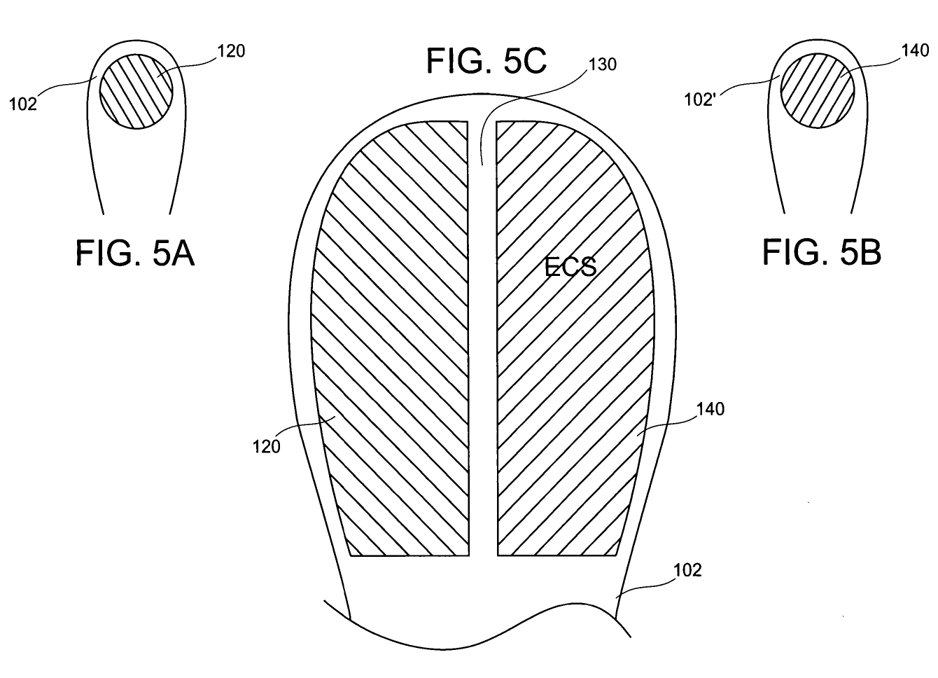

FIG. 4B provides the path affected by an arm traversing from the center outwards on a rotating substrate 50, in accordance with one embodiment of the present invention. As the substrate 50 is spinning in the direction 55, the arm 102 traversing over the surface of the substrate 50 in the direction 106 affects an unwinding path. Similarly, although not shown in FIG. 5B, a second arm 102′ moving from over the center to over the edge of the substrate 50 would affect an unwinding path of data points 21.

FIG. 5A provides a depiction of the arm 102 containing an optical sensor 120. The optical sensor 120 may employ one of several techniques for obtaining properties of film on the substrate 50. The film, also being a material on the substrate, includes transmissive films on the substrate 50. Transmissive films include a broad range of dielectric and semi-conductive materials that allow certain wavelengths of light to pass through based on the index of refraction and extinction coefficient of the particular material. Without limitation, example lists of suitable films can be readily obtained from a number of sources. One example source may be A User's Guide to Ellipsometry, Harland G., Tompkins, Academic Press, Inc., New York, 1993, pg. 253-255, which is herein incorporated by reference. Material on the substrate also includes residues present on the surface of the substrate.

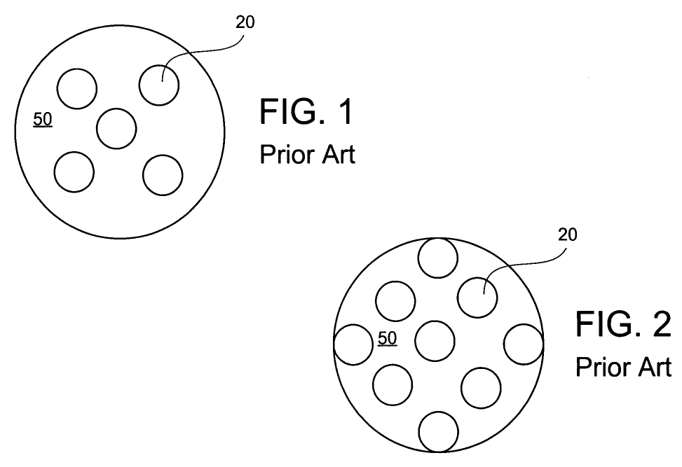

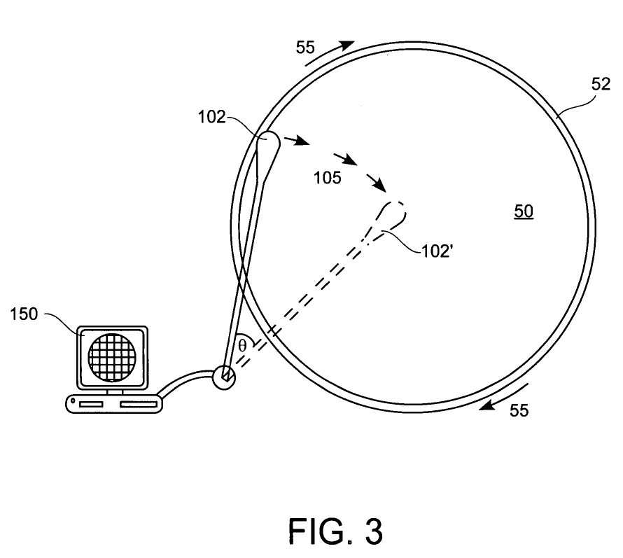

As shown in FIG. 5A-1, the optical sensor 120 includes an illuminating element 123, as well as a spectrograph 129, in accordance with one embodiment of the present invention. The illumination element 123 may be comprised of any suitable light source such as a xenon lamp (180-800 nm) capable of providing broadband wavelengths of light. The selection of the illumination element 123 may be dependent on the type of films to be measured by the optical sensor 120. The illumination element 123 may be continuously illuminated or may be pulsed or flashed at defined periods to enable error subtraction (smoothing or averaging) and addition to cancellation of movement induced by the rotation of the substrate 50 and scanning of the arm 102. The computer 150 in concert with a spectrograph 129 (described below) can control operation of the strobe, including parameters such as the period of flashing the illumination element 123. The illumination element 123 may be housed within the optical sensor 120 at the end of the arm 102. In another embodiment a fiberoptic cable 125 may provide transmission of light from the illumination element 123 through the arm 102 to the optical sensor 120.

Still referring to FIG. 5A-1, in embodiments utilizing a fiberoptic cable or other transmission medium, the optical sensor 120 includes a receiving element, also known as a collimator 124, that is coupled to a fiberoptic cable 125 and is capable of collecting light returning from the surface of the substrate 50. The fiberoptic cable 125 passes the received light to a spectrograph 129, also known as a spectrometer, for analysis. The fiberoptic cable 125 is comprised of at least one fiber 126. In most cases, a plurality of the fiber 126 will be bundled together within the fiberoptic cable 125. The bundle of the fiber 126 within the fiberoptic cable 125 can allow for transmission of the illumination source 123 and collection of signals off the surface of the substrate 50 within the same fiberoptic cable 125. A coupler 127, provides for the fiberoptic cable 125 to be attached to both the illumination source 123 and the spectrograph 129.

The spectrograph 129 may be incorporated in the computer 150, or may be a standalone unit that serves as input into the computer 150. The spectrograph 129 may include a charge-coupled device array (CCD array) 128, an arrangement of semiconductors that provides electric charge output of one semiconductor to charge an adjacent one. The CCD array 128 breaks received light (signal) into discrete wavelengths. The spectrograph 129 may vary the exposure time, thereby producing a number of samples to be integrated into a single data point. Although the above description of the optical sensor 120 in FIG. 5A-1 includes a remote illumination source 123 and a remote CCD array, the optical sensor 120 could incorporate these features in the end of the arm 102 itself.

Material properties of the film on the substrate 50, such as the refractive index of the material, allow certain wavelengths of light to pass through the material while other wavelengths of light are reflected off the top surface of that film layer. Interference based on reflected light from a pair of surfaces provides a means of measuring the thickness of materials. Spectral reflectometry provides a technique for determination of the thickness of film layers by noting the difference in the optical path length between interfaces.

The optical sensor 120 may provide analysis of the thin films using ellipsometry, in accordance with another embodiment of the present invention. Linearly polarized light, provided by an illumination element 123 in the optical sensor 120 or from the illumination element 123 via the fiberoptic cable 125, when reflected off a thin film becomes elliptically polarized. Analysis of this change across the spectrum (provided by spectrograph 129 described above) provides properties of the film such as thickness and the refractive index.

In another example of a technique for making thickness measurements, the optical sensor 120 can utilize is a system of parallel light beams, having large inspection spots (up to and greater than 20 mm) without auto-focusing and pattern recognition. The parallel light beam technique is described in “Performing STI process control using large-spot-size Fourier-transform reflectometry” by Dag, Ayelet et al. Micro, April 2003, pgs. 25-30, incorporated by reference herein. A spectrophotometer may be used for analysis of reflected light collected off the surface of the substrate 50, similarly as discussed in the reflectometry section above. In the present invention, reduction of the data acquisition rate and the averaging or smoothing applied can allow for suitable deployment of the optical sensor 120 in a path over a substrate 50 in rotation.

As shown in FIG. 5B, a second arm 102′ is capable of incorporating an inductive sensor 140 that is configured to detect conductive material properties on the substrate 50. In one embodiment, the inductive sensor 140 may detect a signal indicating a film thickness. In the case of conductive films on the substrate 50, the inductive sensor 140 is capable of detecting a signal produced by a magnetic field emitted by the induced current.

Still referring to FIG. 5B, the inductive sensor 140 may be used for displacement, proximity and film thickness measurements of conductive materials. The sensors rely on the induction of current in a sample by the fluctuating electromagnetic field of a test coil proximate to the object being measured. Fluctuating electromagnetic fields are created as a result of passing an alternating current through the coil. The fluctuating electromagnetic fields induce eddy currents which generate their own fields, superimposing the primary field thereby changing the coils' inductance as described in U.S. patent application Ser. No. 10/186,472.

Frequently, the signal indicating the thickness of the film includes external inductive objects, or third body effects. The computer 150 is capable of receiving input from the inductive sensor 140. The computer 150 may be configured to adjust the signal indicating the thickness of the film from the inductive sensors 140 to substantially remove both external inductive objects and a substrate thickness component. Inductive sensors allow for the contactless measuring of a thin conductive (e.g., metal) film thickness in the full range of thicknesses normally utilized in semiconductor manufacturing, typically varying from about 0-15,000 Angstroms. It has been determined that inductive sensors are capable of providing a fast enough response for a wafer moving under typical loading robotics velocity. Accordingly in the present invention, an inductive sensor 140 attached to an arm 102′ can capture a film thickness profile of the substrate 50 while the substrate 50 is being rotated as discussed above in FIG. 3.

FIG. 5C provides an another arrangement of sensors configured on the arm 102. In this embodiment, an optical sensor 120 and an inductive sensor 140 are attached to an arm 102. The arm 102 provides for the traversing of the optical sensor 120 and the inductive sensor 140 across the surface of the substrate 50 as described above. The optical sensor 120 and the inductive sensor 140 may be separated by a barrier 130 to ensure that close proximity does not create distortion and miscommunication. The barrier 130 may be selected from a group of materials that will not contribute to the signals obtained by neither the optical sensor 120 or the inductive sensor 140. Anti-reflective coatings and other suitable absorbing materials such as plastics, rubber, polyurethane, and kevlar may be used so long as they do not contribute to distortion of optical or inductive signals.

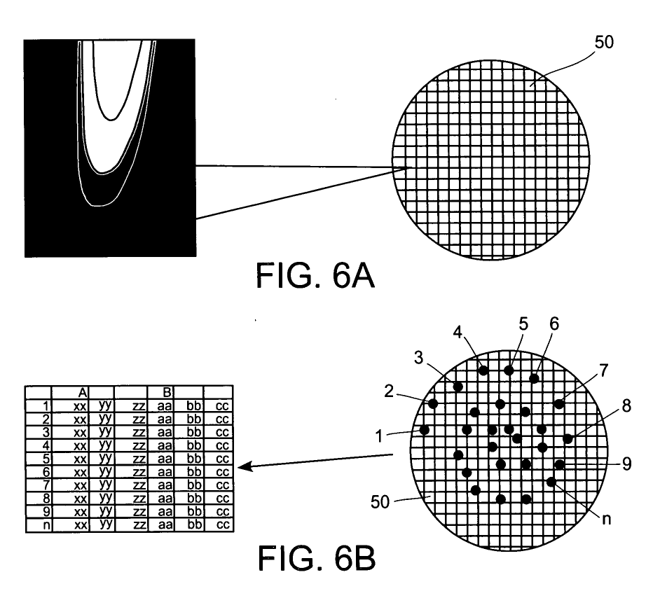

In addition to coordinating the various control activities of the metrology system as described in FIG. 3 above, the computer 150 is capable of receiving information from the inductive sensor 140 and the optical sensor 120 described in FIGS. 5A, 5B, and 5C above. The information obtained from the inductive sensor 140 and the optical sensor 120 is used to generate a film thickness map, also known as a profile of the films on the substrate 50, as shown in FIGS. 6A and 6B. The map provides important information for subsequent processing of the substrate 50. Several embodiments of charts displaying information about the layers on the substrate are described in U.S. patent application Ser. No. 10/331,194, entitled “USER INTERFACE FOR QUANTIFYING WAFER NON-UNIFORMITES AND GRAPHICALLY EXPLORE SIGNIFICANCE”, filed on Dec. 24, 2002, and is incorporated by reference herein. As shown in FIG. 6A, the map may be portrayed using various graphics and colors in order to establish display features such as thickness of films analyzed on the surface of the substrate 50. Three-dimensional (3-D) figures may be used to provide better viewing of information obtained about the stack of films and material on the substrate. As shown in FIG. 6B, data obtained from the sensors may be displayed in a table format such as in a spreadsheet. Columns of data may refer to properties obtained from the respective sensors. The information obtained by the apparatus described in FIGS. 3-6 above may allow for modification of subsequent processes for substrates or corrective action after measurement for substrates undergoing further processing.

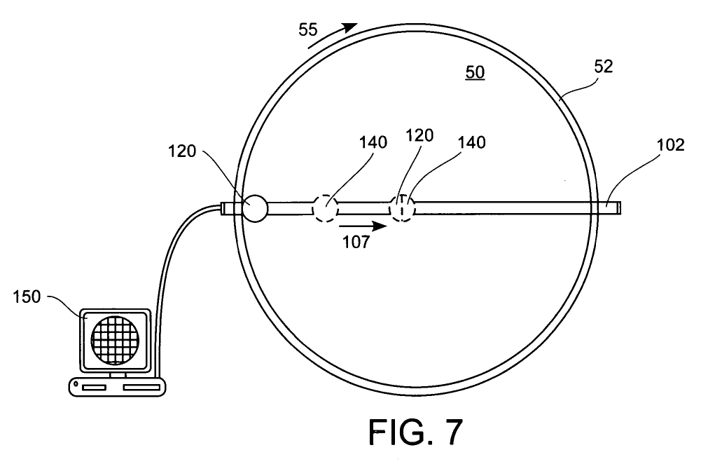

As illustrated in FIG. 7, the optical sensor 120, and the inductive sensor 140 could move linearly in a direction 107 along an arm 102 that extends across a substrate 50 in rotation, in accordance with one embodiment of the present invention. The optical sensor 120 and inductive sensor 140 could transit in concert or independently along the arm 102 that extends across the substrate 50. The computer 150, is capable of providing orchestration of the movement of optical sensor 120 and the inductive sensor 140 in order to produce a complete map of material properties of the substrate 50. The optical sensor 120 and the inductive sensor 140 could also be combined in a single head or other suitable arrangement that would allow both sensors to cover the entire surface of the substrate 50. Information obtained by the optical sensor 120 and the inductive sensor 140 is communicated to the computer 150 for processing as described in the figures above. The communication lines, such as the fiberoptic cables 125 described above, are capable of retraction and coordinated extension to facilitate movement of the sensors on the arm 102 above the substrate 50.

Although the FIGS. 3-7 describe an optical sensor and an inductive sensor, of course multiple optical and inductive sensors could be arranged so as to affect complete mapping of the films on the surface of a substrate in rotation. Several sensors configured on a single arm or on several arms can provide full surface mapping as described in FIGS. 3-7 above. Information obtained by the multiple sensors could be combined or averaged, thereby reducing any errors in the collection effort. Multiple sensors configured at substantially different points along a radius of the substrate in rotation could be added together providing faster full surface coverage of the surface of the substrate.

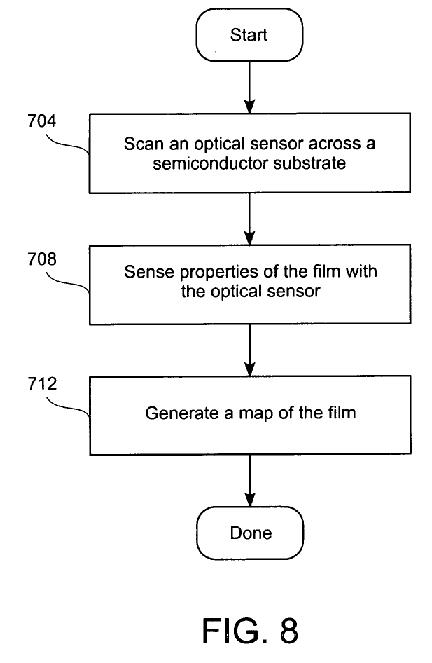

FIG. 8 is a flow chart diagram illustrating an operational method for providing properties of films on a semiconductor substrate in accordance with one embodiment of the invention. Films include resides on the surface of the substrate in addition to material layers contained in and on the substrate. The method begins when an optical sensor is scanned across a path defined along a surface of a spinning substrate having a film, in operation 704. Any suitable robotic, mechanical, or manual technique may be used to spin the substrate and scan the optical sensor across a path along the spinning substrate. The optical sensor is comprised of an illumination element, and a spectrometer or spectrophotometer. A computer determines the rate of the spinning of the substrate and the rate of advancement of the optical sensor.

Properties of the film are sensed with the optical sensor at a plurality of points along the scanning path, in operation 708. The path of the optical sensor may be determined by an arc of the arm that provides for the scanning of the surface of the substrate in rotation. The sensing of the properties is determined by feedback signals from the surface of the substrate. The feedback signals include light in its many forms being returned to the optical sensor from reflection off films on the surface of the substrate. The spectrometer or spectrophotometer in combination with a processor, which may be a computer, is used for the determination of properties of the films based on the signal returned from the surface of the substrate. The optical sensor can also detect residue on the substrate.

Due to the rotation of the substrate, the optical sensor, when scanned across a path extending from the edge to the center of the substrate provides data from the entire surface. The path affected by the optical sensor traversing the substrate from edge to center is one of a spiral. Similarly, the optical sensor is capable of providing data from the entire surface of a substrate in rotation by scanning from the center to the edge.

Feedback from the substrate is collected at a determined sample rate, that is, an amount of time including a pulse of the light source, the signal or signals returned from the surface of the substrate and subsequent processing of that signal or signals. A data point may be determined from one or more samples of the acquired signal or signals after a suitable degree of smoothing, averaging or other algorithm is applied. The size of the area analyzed by the optical sensor is dependent on the illumination region, otherwise known as the spot size provided by the illumination element (light source), and the method of analysis to be performed.

In operation 712, a map of the film or films on a substrate is generated from the information obtained at a plurality of points along the path as discussed in operations 704 and 708 above. A computer assists in the storage of the data acquired and the generation of the map. The map provided may be in the form of a graphical representation of films and residues on the surface of the substrate. Colors, shading and other suitable labels may be used to provide topographic, film thickness, and other material properties obtained by the optical sensor. The map of the film or films on a substrate may also be displayed in a table format or spreadsheet. The map of film or films on the substrate can assist in determination of the quality of devices on the substrate and in subsequent processing steps.

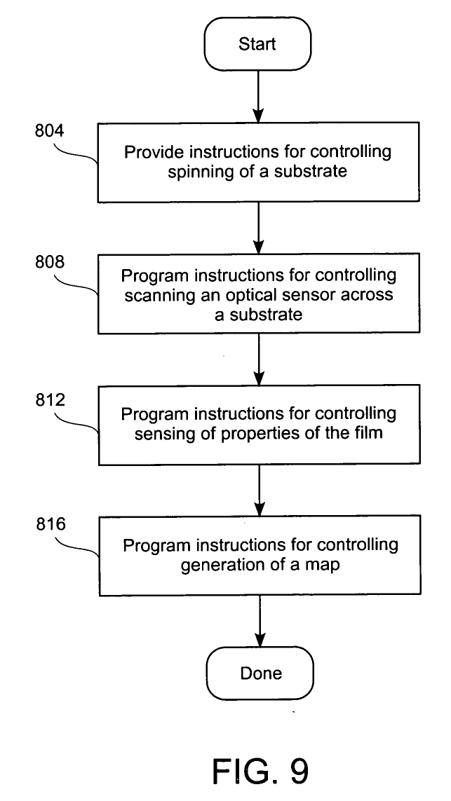

FIG. 9 illustrates a method for providing computer readable media embodying computer code having program instructions, in accordance with one embodiment of the present invention. In operation 804, program instructions provide for controlling the spinning of a substrate having a film. These instructions include the rate of the spinning of the substrate. In operation 808, program instructions provide for controlling scanning of an optical sensor across a path along a surface of a substrate. The rate of advancement of the optical sensor over the surface of the substrate is one such instruction. In operation 812, program instructions for controlling sensing of the properties of the film with the optical sensor at a plurality of points along the path are provided. Instructions for controlling the sensing include the principles addressed in FIGS. 3-7 above such as the period of flashing of a light source and the collection, storage and algorithms applied to a signal received from the surface of the substrate. Program instructions for controlling generation of a map of the film using information from the plurality of points along the path is provided in operation 816. Generation of the map includes algorithms applied to data points as well as presentation of the information on a graphical display such as a computer screen or printed material.

Information obtained by the sensors described in the present disclosure as well as operation of the various pieces of equipment of the present invention are capable of being controlled by a computer employing the use of program instructions. With the above embodiments in mind, it should be understood that the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

Any of the operations described herein that form part of the invention are useful machine operations. The invention also relates to a device or an apparatus for performing these operations. The apparatus may be specially constructed for the required purposes of processing signals obtained by the optical and inductive sensors, or it may be a general-purpose computer selectively activated or configured by a computer program stored in the computer. In particular, various general-purpose machines may be used with computer programs written in accordance with the teachings herein, or it may be more convenient to construct a more specialized apparatus to perform the required operations.

One embodiment of the present invention can also be embodied as computer readable code on a computer readable medium. The computer readable medium is any data storage device that can store data which can be thereafter be read by a computer system. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over network coupled computer systems so that the computer readable code is stored and executed in a distributed fashion.

In summary, the embodiments of the present invention provide a method and apparatus for the efficient measurement and mapping of films by scanning sensors over a rotating substrate. The invention has been described herein in terms of several exemplary embodiments. Other embodiments of the invention will be apparent to those skilled in the art from consideration of the specification and practice of the invention. The embodiments and preferred features described above should be considered exemplary, with the invention being defined by the appended claims.

1. A method, comprising:
spinning a substrate having a film;
scanning an optical sensor across a path along a surface of the substrate;
sensing properties of the film with the optical sensor at a plurality of points along the path; and
generating a map of the film using information from the plurality of points along the path.

2. The method of claim 1, wherein the path of the scanning is from the edge of the substrate to the center of the substrate affecting a path over the surface of the substrate.

3. The method of claim 1, wherein the path of the scanning is from the center of the substrate to the edge of the substrate affecting a reverse path over the surface of the substrate.

4. The method of claim 1, wherein the sensing properties of the film with the optical sensor includes the gathering of light reflected off the surface of the substrate.

5. The method of claim 1, wherein the generating a map includes performing analysis of light reflected off the surface of the substrate and applying the results in one of a graphical representation and a text format representation.

6. The method of claim 1, further comprising;
scanning an inductive sensor across a path along the surface of the substrate.

7. The method of claim 6, wherein the path of the scanning is from the edge of the substrate to the center of the substrate affecting a path over the surface of the substrate.

8. The method of claim 6, wherein the path of the scanning is from the center of the substrate to the edge of the substrate affecting a reverse path over the surface of the substrate.

9. The method of claim 6, wherein the inductive sensor is capable of providing material properties of conductive materials on the surface of the substrate.

10. The method of claim 6, wherein the generating a map includes information obtained from the optical sensor and the inductive sensor provided in one of a graphical representation and a text format representation.

11. A method, comprising:
scanning an optical sensor across a path defined along a surface of a substrate having a film when the substrate is spinning; and
sensing properties of the film with the optical sensor at a plurality of points along the path; and
generating a map of the film using information from the plurality of points along the path.

12. The method of claim 11, wherein the path of the scanning is from the edge of the substrate to the center of the substrate affecting a path over the surface of the substrate.

13. The method of claim 11, wherein the path of the scanning is from the center of the substrate to the edge of the substrate affecting a reverse path over the surface of the substrate.

14. The method of claim 11, wherein the sensing properties of the film with the optical sensor includes the gathering of light reflected off the surface of the substrate.

15. The method of claim 11, wherein the generating a map is accomplished by performing analysis of light reflected off the surface of the substrate and applying the results in one of a graphical representation and a text format representation.

16. The method of claim 11, further comprising;
scanning an inductive sensor across a path along the surface of the substrate.

17. The method of claim 16, wherein the path of the scanning is from the edge of the substrate to the center of the substrate affecting a path over the surface of the substrate.

18. The method of claim 16, wherein the path of the scanning is from the center of the substrate to the edge of the substrate affecting a reverse path over the surface of the substrate.

19. The method of claim 16, wherein the inductive sensor is capable of providing material properties of conductive materials on the surface of the substrate.

20. The method of claim 16, wherein the generating a map includes information obtained from the optical sensor and the inductive sensor provided in one of a graphical representation and a text format representation.

21. A method, comprising:
scanning along a path defined over a region that is to define a surface of a substrate that can have a film, the substrate being configured to spin when present; and
sensing properties of the film at a plurality of points along the path; and
generating a map of the film using information from the plurality of points along the path.

22. The method of claim 21, wherein the path of the scanning is from the edge of the substrate to the center of the substrate affecting a path over the surface of the substrate.

23. The method of claim 21, wherein the path of the scanning is from the center of the substrate to the edge of the substrate affecting a reverse path over the surface of the substrate.

24. The method of claim 21, wherein the sensing properties of the film with the optical sensor includes the gathering of light reflected off the surface of the substrate.

25. The method of claim 21, wherein the generating a map is accomplished by performing analysis of light reflected off the surface of the substrate and applying the results in one of a graphical representation and a text format representation.

26. The method of claim 21, further comprising;
scanning an inductive sensor across a path along the surface of the substrate.

27. The method of claim 26, wherein the path of the scanning is from the edge of the substrate to the center of the substrate affecting a path over the surface of the substrate.

28. The method of claim 26, wherein the path of the scanning is from the center of the substrate to the edge of the substrate affecting a reverse path over the surface of the substrate.

29. The method of claim 26, wherein the inductive sensor is capable of providing material properties of conductive materials on the surface of the substrate.

30. The method of claim 26, wherein the generating a map includes information obtained from the optical sensor and the inductive sensor provided in one of a graphical representation and a text format representation.

31. An apparatus, comprising,
a substrate holding and rotating mechanism; and
an arm, the arm including,
an optical sensor that can be scanned over a surface of the substrate, the optical sensor being configured to sense properties of a film that can be present on the surface of the substrate, the optical sensor being configured to sense the properties at a plurality of points along a path that the arm is capable of traversing over the surface of the substrate.

32. The apparatus of claim 31, further comprising:
a data processor being in communication with the optical sensor, the data processor being capable of receiving the properties sensed by the optical sensor.

33. The apparatus of claim 32, wherein the data processor is capable of generating a map of the substrate using the properties sensed by the optical sensor.

34. The apparatus of claim 33, further comprising;
a sensor capable of being attached to the arm and capable of detecting conductive material properties and in communication with the data processor, the data processor being capable of receiving the properties sensed by the sensor that can be present on the surface of the substrate, the sensor being configured to sense the properties at a plurality of points along a path that the arm is capable of traversing over the surface of the substrate.

35. The apparatus of claim 34, wherein the properties include one or a combination of film thickness, index of refraction, extinction coefficient, conductivity, surface roughness, and topography height variations.

36. The apparatus of claim 34, wherein the sensor capable of measuring conductive materials is an inductive sensor.

37. The apparatus of claim 4, wherein the path is from the edge of the substrate to the center of the substrate affecting a path over the surface of the substrate.

38. The apparatus of claim 34, wherein the sensor is configured on a second arm, the sensor being configured to sense the properties at a plurality of points along a path that the arm is capable of traversing over the surface of the substrate.

39. The apparatus of claim 38, wherein the path of the scanning is from the center of the substrate to the edge of the substrate affecting a reverse path over the surface of the substrate.

40. An apparatus, comprising,
a substrate holding and rotating mechanism;
an arm, the arm including,
an optical sensor that can be scanned over a surface of the substrate, the optical sensor being configured to sense properties of a film that can be present on the surface of the substrate, the optical sensor being configured to sense the properties at a plurality of points along a path that the arm is capable of traversing over the surface of the substrate;
the optical sensor comprising,
an illumination source, the illumination source capable of flashing;
a spectrograph, the spectrograph capable of collecting and analyzing a signal reflected from the substrate;
an inductive sensor capable of detecting conductive material properties at a plurality of points along a path that the arm is capable of traversing over the surface of the substrate; and
a data processor, the data processor being capable of receiving the properties sensed by the optical sensor and the inductive sensor, controlling the operation of the arm and the substrate holding and rotating mechanism and producing a map, the map graphically indicating the properties sensed.

41. Computer readable media embodying computer code having program instructions, the program instructions comprising:
program instructions for controlling spinning of a substrate having an film;
program instructions for controlling scanning of an optical sensor across a path along a surface of the substrate;
program instructions for controlling sensing of properties of the film with the optical sensor at a plurality of points along the path; and
program instructions for controlling generation of a map of the film using information from the plurality of points along the path.
